(19) United States
(12) Patent Application Publication
(10) Pub. No.: US 2007/0157201 A1
(43) Pub. Date: Jul. 5, 2007

(54) CPU resource manager

(76) Inventors: Nicholas J. Schmidt, Brookline, MA (US); Brett D. Granger, Westford, MA (US); Gordon S. Landis, Stow, MA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(21) Appl. No.: 11/323,973

(22) Filed: Dec. 30, 2005

(51) Int. Cl. G06F 9/46

(52) U.S. Cl. 718/100

(57) ABSTRACT

The systems disclosed allow an STB to manage a CPU as a resource. Further, users can be notified of the CPU status and presented with options to modify CPU resource preferences. The systems disclosed allow an STB to manage the CPU when the CPU is running tasks and applications such as DVR and digital video playback, recording and playback of disks including DVDs and CDs, photograph slide shows, and so on.

### FIELD OF THE INVENTION

The invention relates to devices and methods for controlling the function of central processing units within a set top box.

### BACKGROUND OF THE INVENTION

Current cable set top boxes (“STB”s) perform many tasks, including digital video recording (“DVR”), playing MP3s, playing digital photograph slideshows, playing DVDs, recording onto DVDs, rendering or streaming video, providing internet or other network access, playing back from a DVR, etc. Further, the STB can perform many of these functions at the same time. However, the STB's CPU has a limited number of processing cycles available for such multi-tasking. For example, if the STB is recording onto a DVD, this process could potentially shut down other operations or alternately the same could extend the time necessary to perform the process over a very long time because of other operations.

### BRIEF DESCRIPTION OF THE DRAWINGS

FIG. 1 shows a schematic hierarchy of STB components illustrating layers of control.

FIG. 2 shows additional resource managers coupled to a CPU resource manager.

FIG. 3 shows a flowchart illustrating a method where the user can allocate resources according to their desire.

FIG. 4 shows a sample screen of a GUI which may be used in the method of FIG. 3.

FIG. 5 shows how task status is maintained while the CPU shifts from one task to the next.

FIG. 6 shows a flowchart illustrating a method whereby the CPU shifts from one task to the next, or alternatively ends processing of a task if the task is complete.

### DETAILED DESCRIPTION

The systems disclosed allow an STB to manage a CPU as a resource. Further, users can be notified of the CPU status and presented with options to modify CPU resource preferences.

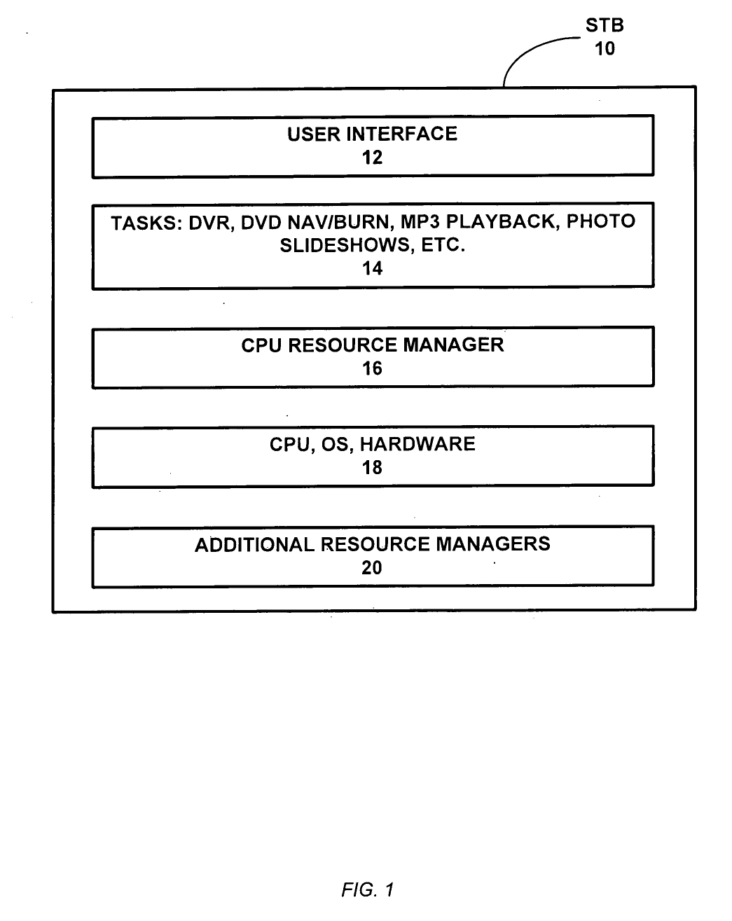

Referring to FIG. 1, a schematic depiction of the layers of control of an STB system 10 is shown. High-level control of the STB is provided by a user through a user interface layer 12. Through this user interface layer 12, in which a textual or graphical representation is provided of currently-running tasks and/or of any potential non-running tasks, a user can choose to run various applications, processes, or tasks, such as recording a TV signal using a DVR, playing back a pre-recorded DVR signal, MP3 playback and recording, disk playback or recording, including CD, DVD, and MP3 disks, digital photograph slideshows, etc.

In this description, the term “task” is employed to mean a complete function performed by an STB or a residential gateway. A CPU Resource Manager refers to a separate circuit, such as an ASIC or FPGA, or a circuit implemented in software, programmed to control what task the CPU performs and when each portion of a task is performed with respect to portions of other tasks also being performed.

User commands from the user interface layer 12 choose which tasks in task layer 14 commence, continue, and end execution. Execution of any of these tasks requires operation of at least some of a plurality of subsystems 18: a central processing unit (“CPU”), an operating system (“OS”), a hard disk and its associated controller, and other hardware, software, and firmware.

In addition to choosing which tasks to execute, the user interface layer 12 provides the user with a display, menu, or other such interface through which the user can provide input as to how CPU access is allocated. This allocation may be among currently-running tasks or may alternatively correspond to how CPU access by a newly-commenced task will affect processing of other currently-running tasks. In one system, the allocation may simply be that a particular task is preferred or should be given priority. In this system, the preferred or prioritized task may be allocated, e.g., 50% of CPU access time while the remaining tasks share the remaining 50%. This percentage may of course vary. For example, if the preferred task is DVR playback, this may be allocated an even greater percentage due to the deleterious results of slow playback. That is, slow DVR playback is highly noticeable to the user. On the other hand, slow DVD recording may not be very noticeable to a user, so a lesser percentage of CPU access may be allotted for such a task, even where such a task is the preferred or chosen task.

In another system, the user may directly allocate a specific percentage of CPU access time to each task. While this user interface may be more difficult for the user to operate, the same provides a greater level of control.

However the user interface layer 12 receives its instructions, the same implements the CPU allocation through a CPU resource manager 16. The CPU resource manager 16 controls which and how tasks are given access to the CPU. In particular, the CPU resource manager 16 monitors CPU usage and regulates the level of access each task has to the CPU. The CPU resource manager 16 then controls the plurality of subsystems 18 including the CPU, hard disk, operating system, and other system resources to accomplish the results of the user input. For example, if the user desires to give preference to playback of a television program, the DVR is chosen as a preferred application and the same is given preferred access to the CPU, operating system, and hard disk.

Various examples of the operation of CPU resource manager 16 are provided below. The level of CPU access and control can vary from a system in which the CPU resource manager 16 automatically allocates CPU access based on a predetermined set of rules to a system in which the CPU resource manager 16 is completely dependent on user allocation choices to determine CPU access.

In one system with minimal CPU resource management, the CPU resource manager 16 may simply allot CPU preference on a “first-come-first-served” basis. In other words, the first task to be chosen by the user could be given preference to the CPU until the task concludes. This preference may either terminate or toll other tasks or provide the other tasks with greatly reduced CPU access. In some cases, this may undesirably preclude use of the CPU for any other tasks for an extended period of time.

In a more sophisticated and general system, the CPU resource manager 16, based on user input, apportions a designated amount of CPU, measured, e.g., by time or resources, that is reserved for a particular task or tasks. As noted above, this may be by a preference or priority level setting for each task. In this case, a portion of CPU access could be set where the more preferred or priority tasks receive a higher portion of CPU access based on an algorithm or other scheme. In another system, the CPU may perform a portion of a task as measured by the percentage computation time, i.e., number of clock pulses, which is given to the task. Rather than percentage of computing time, a certain number of programming lines or instructions may be performed, with a higher percentage yielding a higher number of instructions performed. In yet another system, the time required to complete a latest operation of each task, e.g., a DVD “burn”, may be displayed and may be alterable by the user by shifting CPU access preferences using the user interface.

In cases where an algorithm or other scheme is employed, the same may also take into account the ease with which the task or operation may be performed. For example, a request of an on-demand television program requires little processing, while recording onto a DVD is very processor-intensive. In some systems, the request may take precedence due to its ease of performance.

The CPU resource manager 16 may also take into account certain rules and may provide the user interface with user options corresponding to these rules. As one example, a CPU resource manager default policy may be set such that video playback from the DVR is preferred and that any other CPU activity is subsumed to that process. As another example, if the user requests preference be given to the DVD-recording task, the user interface may interpose a warning that video playback may be unsatisfactory due to this preference request.

In more detail, given the monitoring of the CPU by the CPU resource manager 16, the CPU resource manager 16 may provide alerts to the user interface layer 12 that the CPU is not available for a certain task, or that execution of that task will be slow. The user, through user interface layer 12, can also choose between certain options, such as allowing a certain task to be slow or canceling or tolling, i.e., temporarily stopping, execution of other tasks so that the chosen task may execute in a timely or otherwise preferred manner.

As noted above, where a preference or priority level is set, the more preferred or priority tasks receive a higher portion of CPU access based on an algorithm or other scheme. Where a preference or priority level is set high, that operation or task may be considered to be running in the foreground. Alternatively, if the user is currently viewing the results of a particular task, e.g., DVR playback, then that task may also be considered to be running in the foreground. Where a preference or priority level is set low, that operation or task may be considered to be running in the background. Similarly, if the user is not currently viewing the results of a particular task, e.g., DVD recording, and that task is not considered important or vital to be performed in a timely manner, then that task may also be considered to be running in the background.

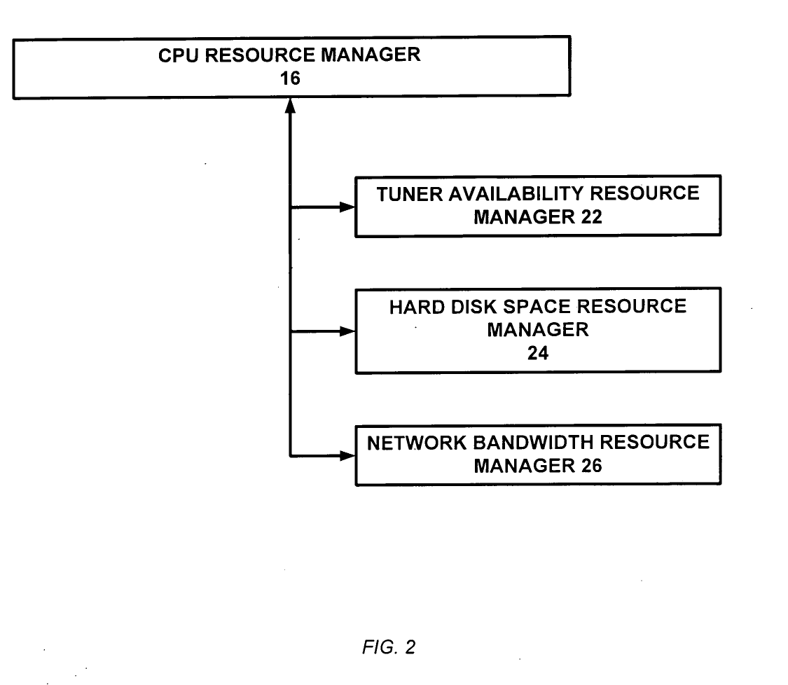

Referring to FIGS. 1 and 2, the CPU resource manager 16 may be coupled to other resource managers 20, such as a tuner availability resource manager 22, a hard disk resource manager 24, a network bandwidth resource manager 26, etc. These other resource managers may be coupled to the CPU resource manager 16 such that the latter controls their function to efficiently accomplish the goals of the user input. In some cases, the other resource managers may perform messaging to the upper layers, such as the user interface, so as to allow direct user control of the same. For example, the user may provide input to directly control the tuner availability resource manager 22 to preferentially accomplish recording of a chosen television program. In a case where such direct control affects operation of other currently-running tasks, the CPU resource manager 16 may request confirmation by the user, or adjustment of the CPU access preference of other currently-running tasks, through the user interface.

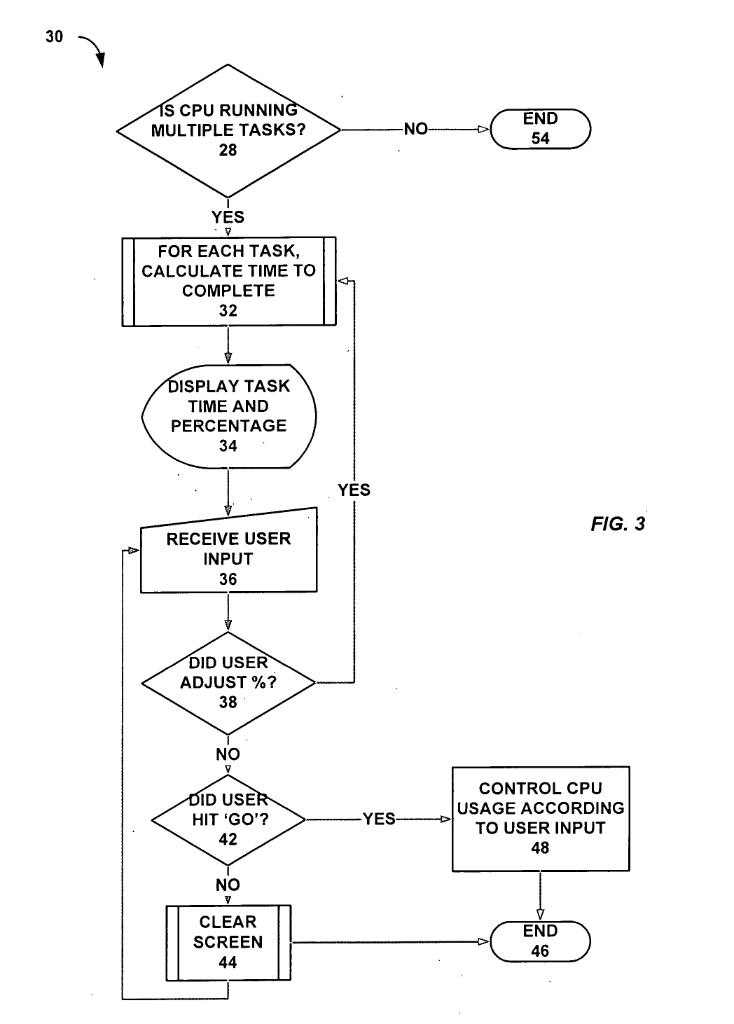

Specific examples of the system and method are now provided. Referring to FIG. 3, a method is shown in which a user may change the CPU allocation as they see fit. In this method 30, a first check is whether the CPU is running multiple tasks (step 28). If the CPU is not running multiple tasks, then there is no need to apportion CPU resources and the method may end (step 54). However, if the CPU is running multiple tasks, then the time to complete each task may be calculated (step 32), and displayed to the user (step 34). A user may then provide input (step 36) if they wish to alter the allocation, which then alters the calculated time for each task to complete. Thus, a check is made as to whether the user adjusted the percentage allocation (step 38). If so, the time to complete each task is recalculated (step 32), and the process begun again. Once the user accepts the allocation, the user can commence the processing of the tasks, here shown as the user “hitting” a “GO” button (step 42). If the user fails to do so within a predetermined amount of time, then the system can return to the point at which user input is solicited (step 36). If the user causes the method to commence, then the CPU is controlled according to the user input (step 48) and the method ends (step 46).

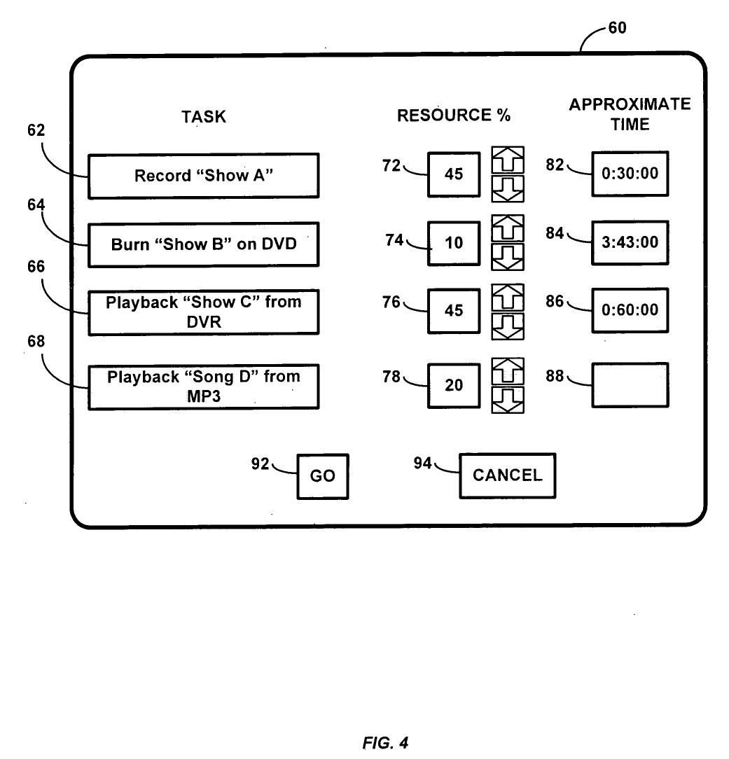

A GUI 60 according to this method is shown in FIG. 4. A series of tasks 62-68, along with designated resource allocations 72-78, by percentage, along with approximate times 82-88 to complete the respective tasks. A “GO” button 92 and “CANCEL” button 94 are also provided. Various points are notable.

First, certain of the tasks are time-sensitive while others may be considered time-insensitive. For example, the record and playback tasks 62, 66, and 68 are time-sensitive in that a user would find gaps in such tasks extremely noticeable and likely unacceptable. However, the burn task 64 may experience gaps but this is not noticeable to the user as they user is not typically paying attention to such burn tasks. In this way, this task is time-insensitive.

Time-sensitive tasks often require some minimum percentage of CPU resource allocation. In other words, if such tasks are not afforded this minimum percentage, gaps or other deleterious features appear in the performance of the task. As can be seen from FIG. 4, time-sensitive tasks 62 and 66 have each been given an exemplary minimum CPU resource allocation of 45%. As the time-insensitive burn task 64 can run in the background, the same has been given an exemplary CPU resource allocation of 10%. These allocations may be adjusted upward or downward by the buttons to the right of the percentage allocation.

In the example of FIG. 4, a user has attempted to add a fourth task 68, the playback of a song. However, being a time-sensitive task, the same requires a minimum CPU resource allocation. If this task requires, e.g., 20%, then the task cannot be added as the total CPU resource allocation would be 110%, i.e., more than the CPU can perform. Thus, the system “grays out” these buttons, not allowing the user to add the task. In an alternative system, the system may allow the user to add the task but may alert the user that playback of the time-sensitive tasks may then be jittery or experience gaps.

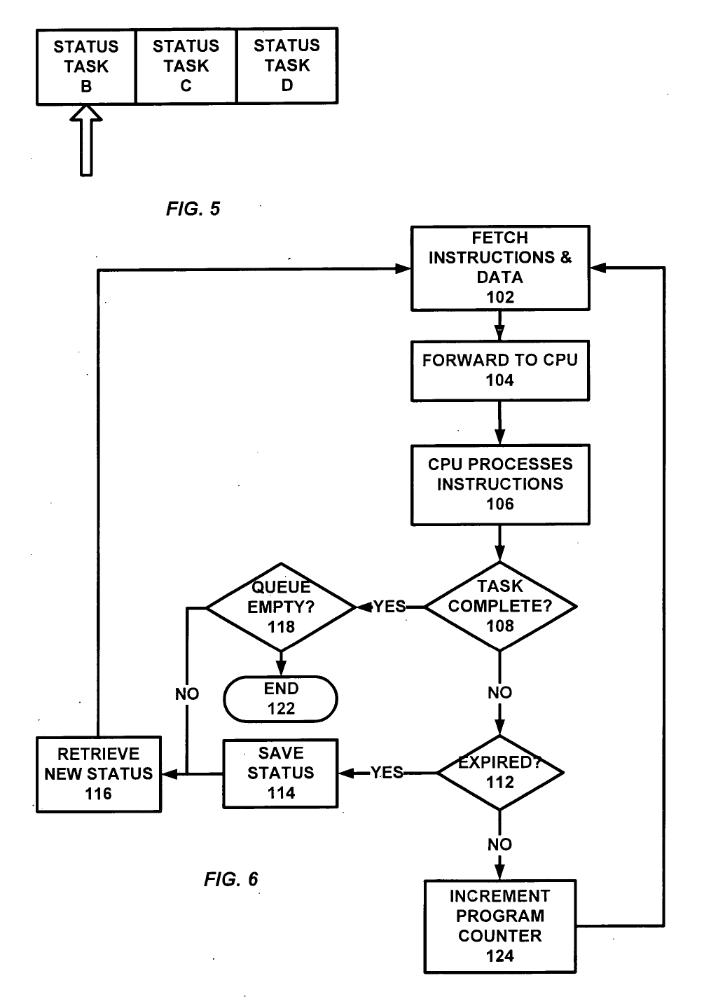

Referring to FIG. 5, a pointer is shown pointing to the status of exemplary task B. In this figure, task B is that which is currently the subject of the CPU's computations. Following the end of the allotted period of time for task B, the CPU and the pointer will move to task C, and then to task D. In each case, as the time for a task draws to a close, information concerning the status of the soon-to-be-completed task is stored, including such information as data being operated on and instruction line number.

In more detail, referring to FIG. 6, the initial step when a CPU takes up a task, whether the task has been worked on previously or not, is to fetch needed instructions and data (step 102) and forward them to the CPU (step 104) where the CPU can process the same (step 106). During this processing, the task may complete (step 108). If it does not complete, then the processing occurs until the allocation time expires (step 112). As noted above, the expiration may occur due to a percentage-based time elapsing, a certain number of instructions being executed, etc. If expiration has not occurred, then the program counter is incremented (step 124) and processing proceeds to the step in the program, which again causes instructions and data to be fetched, and the process repeated (step 102). Note that the process generally should not end in the middle of an instruction being executed.

If the task completes during the cycle, then a check is made as to whether the queue is empty (step 118). In other words, a check is made as to whether another task may be executed, as if one task ends, there should be no need to wait until the end of the completed task's allocated time prior to continuing CPU execution of the following task. If there are no tasks waiting to be performed, the method may end (step 122). If another task may be executed, then the status of the next task is retrieved (step 116) and processing continued by the fetch of appropriate instructions and data (step 102).

However, if the percentage-based time, or other measure of allocation, expires during execution, then the status of that task is saved (step 114), the status of the next task is retrieved (step 116), and processing continues by the fetch of appropriate instructions and data (step 102).

Advantages of the invention may include one or more of the following. With a CPU resource manager, the user may be informed when a chosen task will have an extended duration, e.g., the user interface may display “Burning this DVD will take 3 hours and 43 minutes”. The user may also be given a choice as to which process will be given preference, e.g., “Please select one of the following: Burn DVD in background, which will take 3 hours and 43 minutes; or Burn DVD in foreground, which will take 33 minutes, but will make DVR playback impossible”. Further, the invention is not limited to set-top boxes: any product that has significant multi-tasking and limited CPU bandwidth could benefit from the systems disclosed.

While the above description has been provided using the examples of recording a TV signal using a DVR, playing back a pre-recorded DVR signal, and recording a DVD, it should be clear to one of ordinary skill in the art that other applicable tasks include recording and playing back MP3 files, transferring a recorded file, e.g., a song or TV show, to another STB, playing digital photograph slideshows, playing a DVD, etc. Further, while the term “currently-running” has been employed to mean processes, tasks, and applications that are running on a single CPU, the term could also apply to processes, tasks, and applications running concurrently on multiple processors.

It should be noted that the process shown in the figures may be implemented in a general, multi-purpose or single purpose processor. Such a processor will execute instructions, either at the assembly, compiled or machine-level, to perform that process. Those instructions can be written by one of ordinary skill in the art following the description of the figures and stored or transmitted on a computer readable medium. The instructions may also be created using source code or any other known computer-aided design tool. A computer readable medium may be any medium capable of carrying those instructions and include a CD-ROM, DVD, magnetic or other optical disc, tape, silicon memory (e.g., removable, non-removable, volatile or non-volatile), packetized or non-packetized wireline or wireless transmission signals.

It should be noted that the description above refers to specific examples of the invention, but that the scope of the invention is to be limited only by the scope of the claims appended hereto.

1. A computer readable medium having computer-executable instructions for controlling access to a CPU in a set-top box, whereby at least two concurrently-running tasks share a CPU, comprising instructions for:
a. displaying a textual or graphic representation of each of at least two currently-running tasks;
b. accepting a user input as to when each of the concurrently-running tasks is executed by the CPU;
c. controlling the CPU to execute both tasks corresponding to the user input.

2. The medium of claim 1, wherein the controlling includes: allowing instructions for the tasks to be processed by the CPU at controlled times, or sending a signal to the CPU instructing the CPU to change tasks.

3. The medium of claim 1, wherein the controlling includes controlling the CPU based on percentage of time allotted to each task corresponding to the user input or controlling the CPU based on number of instruction executed corresponding to the user input.

4. The medium of claim 1, wherein if one of the currently-running tasks includes recording to a disk, further comprising displaying a user input choice of only running the recording to a disk and terminating or tolling any other currently-running tasks.

5. The medium of claim 1, further comprising calculating the approximate amount of time required to complete at least one of the concurrently-running tasks.

6. The medium of claim 1, wherein the preferentially-run task is digital video playback.

7. The medium of claim 1, further comprising displaying a time remaining for each of the currently-running tasks to complete a current operation.

8. The medium of claim 1, further comprising accepting a user input regarding whether any of the currently-running tasks should be run in a foreground mode or in a background mode.

9. A computer readable medium having computer-executable instructions for controlling CPU processing in a set-top box, whereby a task is commenced while other tasks are running, comprising instructions for:
a. accepting a user input as to a task to be run;
b. displaying the approximate time to execute the task and the concurrently-running tasks;
c. accepting a user input as to whether: preference to the CPU should be given to the task; preference to the CPU should be given to one or more of the existing currently-running tasks; the task should be cancelled; or one or more of the existing currently-running tasks should be cancelled;
d. directing the CPU to preferentially run the task corresponding to the user input.

10. The medium of claim 9, wherein if the task or one of the existing currently-running tasks includes recording to a disk, further comprising displaying a user input choice of only running the recording to a disk and terminating or tolling any other currently-running tasks.

11. The medium of claim 9, wherein the accepting a user input further comprises accepting a user input corresponding to the priority of the task and to each of the existing currently-running tasks.

12. The medium of claim 11, wherein the priority of the preferentially-run task causes the preferentially-run task to consume 100% of the CPU access time.

13. The medium of claim 9, wherein the currently-running tasks are selected from the group consisting of: digital video recording or playback, playing a digital photo slideshow, recording onto a disk, and playing a disk.

14. The medium of claim 9, wherein the preferentially-run task is digital video playback.

15. The medium of claim 7, further comprising displaying a time remaining for the task and for each of the currently-running tasks to complete a current operation.

16. The medium of claim 9, further comprising accepting a user input regarding whether the task or any of the currently-running tasks should be run in a foreground mode or in a background mode.

17. A set-top box, comprising:
a. A user interface for accepting a user input;
b. A plurality of task subsystems for performing tasks called upon by the user input to the user interface;
c. A central processing unit to process instructions from the user interface and the plurality of task subsystems;
d. A storage medium to store content accessed by at least some of the plurality of task subsystems;
e. An operating system to control operation of the user interface, the plurality of task subsystems, the central processing unit, and the storage medium; and
f. A CPU resource manager to control access by the plurality of task subsystems to the central processing unit according to accepted input by the user interface.

18. The set top box of claim 17, wherein the plurality of task subsystems are selected from the group consisting of: digital video recording or playback, playing a digital photo slideshow, recording onto a disk, and playing a disk.

19. The set-top box of claim 17, further comprising at least one additional resource manager selected from the group consisting of: a tuner availability resource manager, a hard disk space resource manager, and a network bandwidth resource manager.
